(19) United States
(12) Patent Application Publication
(10) Pub. No.: US 2011/0039232 A1
(43) Pub. Date: Feb. 17, 2011

(54) MAXILLARY SINUS MEMBRANE LIFTING DEVICE FOR DENTAL IMPLANT

(76) Inventor: Yang Eun Yu, Gyeonggi-do (KR)

Correspondence Address: CHRISTOPHER PAUL MITCHELL, 888 16TH ST., NW, SUITE 800, WASHINGTON, DC, 20006, US

(21) Appl. No.: 12/989,075

(22) PCT Filed: Jun. 2, 2008
(86) PCT No.: PCT/KR2008/003084

§ 371 Date: Oct. 21, 2010

(30) Foreign Application Priority Data
Apr. 22, 2008 (KR) 10-2008-0037251

(51) Int. Cl. A61C 8/00

(52) U.S. Cl. 433/173

(57) ABSTRACT

An assistant device for dental implant surgery to perform an operation for placing a dental implant into a thinned maxilla without damage in a maxillary sinus membrane. The assist device includes a cylindrical main support section (22) having a regulator section (23) integrally formed on a lower end portion thereof; and an expandable bag (25) provided in an internal space (24) of the support section (22). When the expandable bag (25) is inflated, a maxillary sinus membrane (13) is elevated into a maxilla (10).

### TECHNICAL FIELD

The present invention relates to an assistant device for dental implant surgery, and more particularly, to an assistant device for dental implant surgery in an operation for placing a dental implant into a thinned maxilla without damage in a maxillary sinus membrane.

### BACKGROUND ART

In general, the dental implant surgery is a surgery that is performed to artificially place a dental implant into an alveolar bone, instead of a missing or vanished tooth. The dental implant surgery has many methods to perform the operation according to a placement position, such as the upper teeth, the lower teeth, a molar tooth, a front tooth, or the like.

In particular, as shown in FIG. 9, maxillary sinuses 500 are formed as cavities on both sides of the nose, under which the molar teeth are positioned in the most part. When a molar tooth is missing, the corresponding maxillary sinus 500 gradually expands, whereas the maxilla 501 under the maxillary sinus is gradually wasted, so that it may be difficult to place a dental implant.

In general, for placement of a dental implant, a fixture for implant is firstly placed into an alveolar bone. The placement depth of the fixture is approximately 7 mm to 14 mm, and the thickness of the alveolar bone (or maxilla) should be greater than that of the former.

However, when the maxilla has been wasted away to a thickness of approximately 3 mm or 8 mm, the fixture cannot be placed in the maxilla. Since the remaining part of the maxilla has a thickness of 5 mm or, more frequently, a less thickness due to some factors, such as the absorption loss ratio of the remaining maxillary alveolar bone after being extracted, and the size and position of the maxillary sinus above a placement position of a dental implant, the dental implant surgery is hardly performed. Thus, if the maxilla is wasted, an artificial bone is first formed in the upper side of the maxilla, i.e. toward the maxillary sinus, and then the fixture is formed.

However, inside such a maxillary sinus, a maxillary sinus membrane 503 has been formed, so that if the maxillary sinus membrane is damaged, inflammation of the maxillary sinus may problematically occur. That is, the fixture can be placed only after the maxillary sinus membrane is lifted toward the maxillary sinus without damaging the membrane, and the artificial bone is formed in that space.

When the maxilla is severely wasted, in the prior art, a method of elevating the maxillary sinus membrane 503 is used to solve the problem. The elevation method of the prior art is conducted such that the maxillary sinus membrane is elevated using an elevator appliance 510 through a hole, which is formed by a lateral approaching method as shown in FIG. 9. Further, if the waste of the maxillary sinus is not relatively severe, an elevation method is used in which the maxillary sinus is elevated by tapping the maxillary sinus with a metal rod type tool. However, according to the prior elevation methods, the maxillary sinus membrane 503 is subject to damage, so that inflammation of the maxillary sinus may occur.

Further, since the degree of elevation of the maxillary sinus is not known, the precision of the implant surgery cannot be obtained. Therefore, there is a need for a technology that can elevate the maxillary sinus more accurately and safely.

### DISCLOSURE OF INVENTION

### Technical Problem

The present invention has been made to solve the foregoing problems with the prior art, and therefore the present invention is directed to an assistant device for dental implant surgery in which an operation of placing a dental implant into a thinned maxilla can be easily performed without causing damage to a maxillary sinus membrane.

The present invention is also directed to an assistant device for dental implant surgery in which, even if a dental implant is placed in a thinned maxilla by elevating a maxillary sinus membrane and then forming an artificial bone in an elevated area, can safely perform the dental implant placement without causing disease in or damage to the maxillary sinus membrane according to the elevation of the membrane, thereby preventing secondary disease from occurring.

The present invention is further directed to an assistant device for dental implant surgery by which, although the maxillary sinus membrane is elevated through the dental implant surgery, particular foreign substances are not introduced between the maxillary sinus membrane and the maxilla, so that there is no risk of infection by the foreign substances, and in which the surface of an expandable bag is smooth, so that safe, quick elevation can be performed without causing damage to the maxillary sinus membrane, and thus entire dental implant surgery is made easy, short, and safe.

### Technical Solution

According to an aspect of the present invention, there is provided an assistant device for dental implant surgery, which includes a cylindrical main support section (22) having a regulator section (23) integrally formed on a lower end portion thereof; and an expandable bag (25) provided in an internal space (24) of the support section (22). When the expandable bag (25) is inflated, a maxillary sinus membrane (13) is elevated into a maxilla (10).

The main support section (22) has a threaded portion (221) on an outer surface thereof so as to be fixed into a maxillary hole (12) of the maxilla.

The main support section (22) is provided with an auxiliary fixture (26), which is screw-engaged with the threaded portion (221) of the support section (22), so that the support section is fitted into the maxillary hole (12) by a depth according to the level by which the auxiliary fixture (26) is screwed.

A pressure inflator (30) is further connected to the internal space (24) so as to inflate the expandable bag (25) with gas or liquid supplied from the pressure inflator (30).

The pressure inflator (30) is provided, in one side thereof, with an injecting connector (32), which is inserted into and is connected to the space (24), and the connector (32) is covered with a rubber packing (33) on an outer surface thereof.

### Advantageous Effects

As set forth above, the assistant device for dental implant surgery has an effect that the dental implant is easily placed in the thinned maxilla without causing damage to the maxillary sinus membrane.

Further, even in the case where dental implant placement is performed to the thinned maxilla, so that the maxillary sinus membrane is elevated, and then an artificial bone is formed therein, the dental implant placement is safely performed without causing disease in or damage to the maxillary sinus membrane according to the elevation of the membrane, preventing the causing of a secondary disease.

Furthermore, although the maxillary sinus membrane is elevated through the dental implant surgery, particular foreign substances are not introduced between the maxillary sinus membrane and the maxilla, so that there is no risk of infection by the foreign substances, and the surface of the expandable bag is smooth, so that safe, quick elevation can be performed without causing damage to the maxillary sinus membrane, and thus entire dental implant surgery is made easy, short, and safe.

### BRIEF DESCRIPTION OF THE DRAWINGS

FIG. 1 is a perspective view illustrating an assistant device for dental implant surgery according to the present invention;

FIG. 2 is a view illustrating the state in which the assistant device for dental implant surgery according to the present invention is not yet coupled to a maxilla;

FIG. 3 is a view illustrating a procedure in which the assistant device for dental implant surgery according to the present invention is being coupled to the maxilla;

FIG. 4 is a view illustrating the state in which the assistant device for dental implant surgery according to the present invention is coupled to the maxilla;

FIG. 5 is a view illustrating the state in which the assistant device for dental implant surgery according to the present invention is coupled to the maxilla but is not yet connected to a pressure inflator;

FIG. 6 is a view illustrating the state in which the assistant device for dental implant surgery according to the present invention is coupled to the maxilla, and the expandable bag is inflated, elevating the maxillary sinus membrane;

FIG. 7 is a view illustrating the state in which an artificial bone is formed in an area under the maxillary sinus membrane which was elevated by the assistant device for dental implant surgery according to the present invention;

FIG. 8 is a view illustrating the state in which a dental implant is placed into the artificial bone, which was formed in the area under the maxillary sinus membrane after the maxillary sinus membrane was elevated by the assistant device for dental implant surgery according to the present invention; and

FIG. 9 is a view illustrating a dental implant surgery according to the prior art.

### MODE FOR THE INVENTION

Hereinafter, the present invention will be described more fully with reference to accompanying drawings, in which an exemplary embodiment thereof is shown.

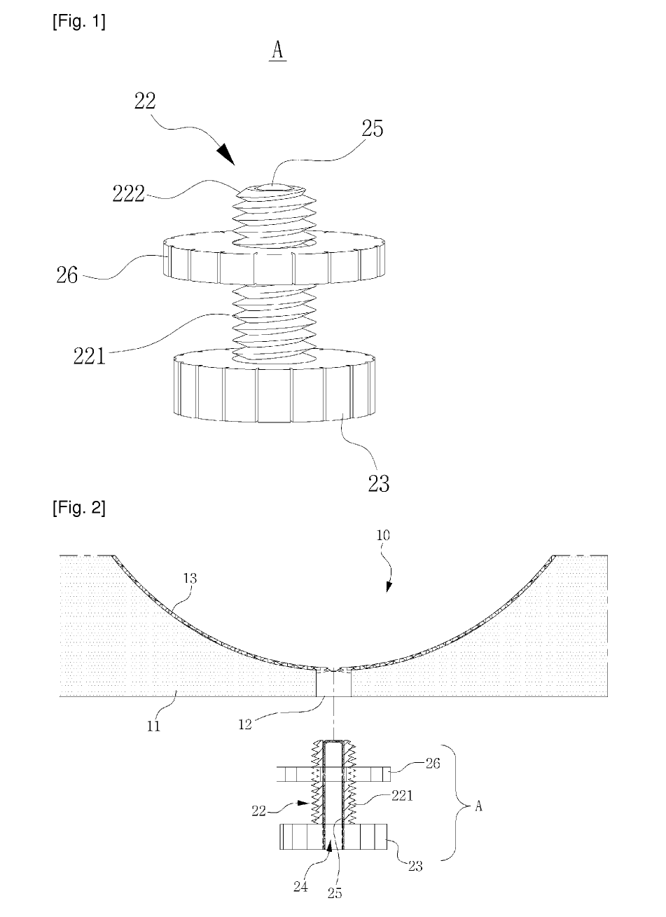

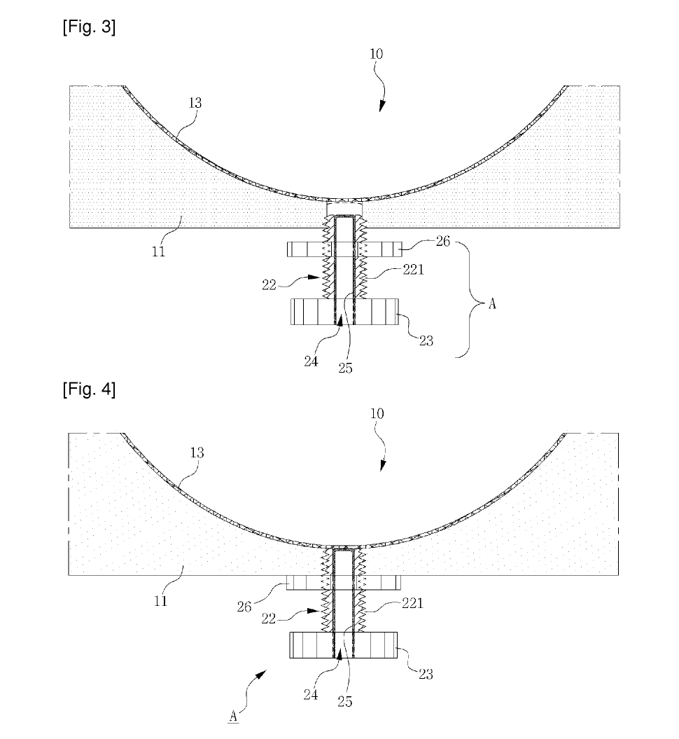

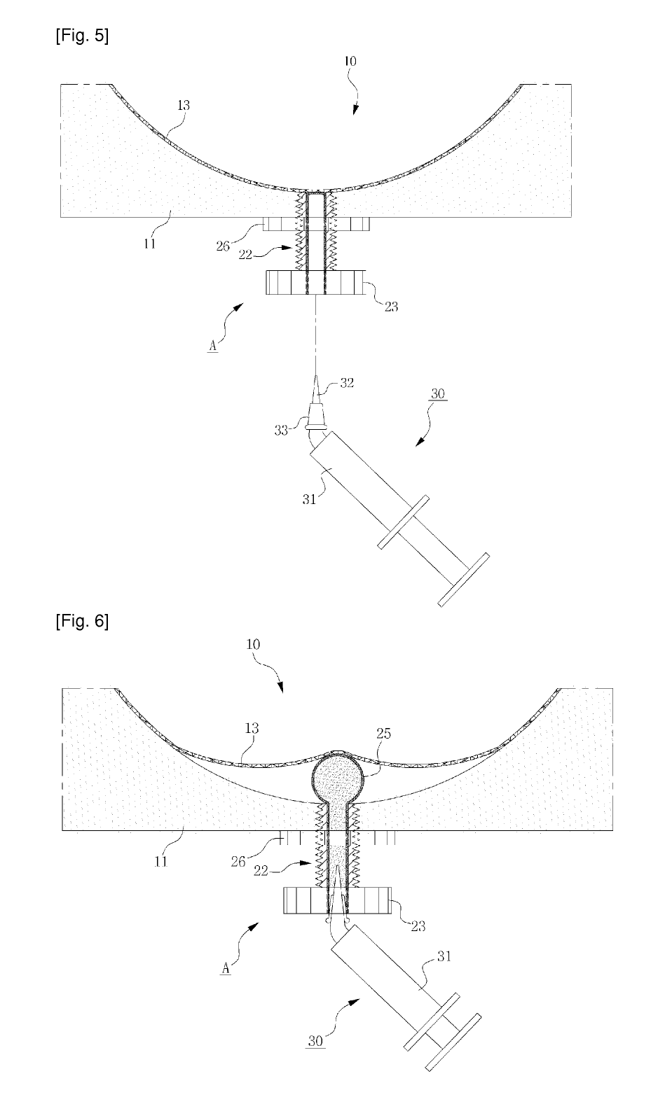

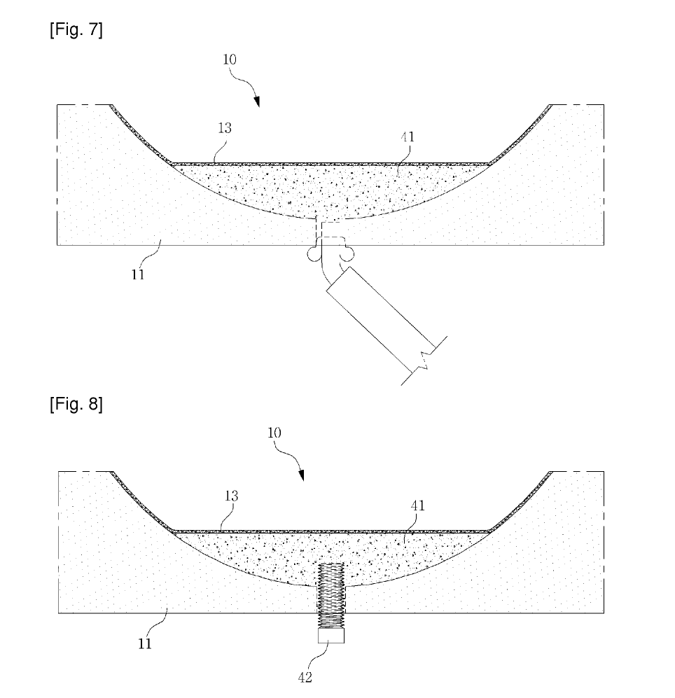

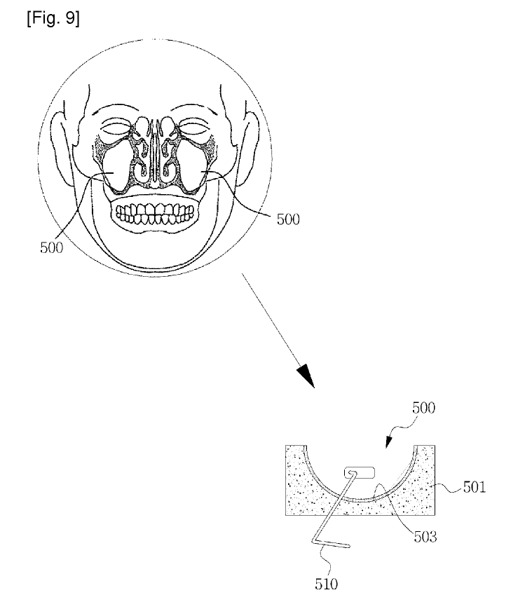

FIG. 1 is a perspective view illustrating an assistant device for dental implant surgery according to the present invention; FIG. 2 is a view illustrating the state in which the assistant device for dental implant surgery according to the present invention is not yet coupled to a maxilla; FIG. 3 is a view illustrating a procedure in which the assistant device for dental implant surgery according to the present invention is being coupled to the maxilla; FIG. 4 is a view illustrating the state in which the assistant device for dental implant surgery according to the present invention is coupled to the maxilla; FIG. 5 is a view illustrating the state in which the assistant device for dental implant surgery according to the present invention is coupled to the maxilla but is not yet connected to a pressure inflator; FIG. 6 is a view illustrating the state in which the assistant device for dental implant surgery according to the present invention is coupled to the maxilla, and the expandable bag is inflated, elevating the maxillary sinus membrane; FIG. 7 is a view illustrating the state in which an artificial bone is formed in an area under the maxillary sinus membrane which was elevated by the assistant device for dental implant surgery according to the present invention; and FIG. 8 is a view illustrating the state in which a dental implant is placed into the artificial bone, which was formed in the area under the maxillary sinus membrane after the maxillary sinus membrane was elevated by the assistant device for dental implant surgery according to the present invention.

That is, the assistant device for dental implant surgery A, as illustrated in FIGS. 1 to 8, includes a cylindrical main support section 22, a regulator section 23 integrally formed on a lower end portion of the main support section 22, and an expandable bag 25 provided in an internal space 24 of the support section 22, at the side of the maxillary sinus 10. When the expandable bag 25 is inflated, it elevates a maxillary sinus membrane 13 toward the inside of the maxillary sinus 10.

Thus, the maxillary sinus membrane 13 is separated from the maxilla 11 of the maxillary sinus 10. The separation of the maxillary sinus membrane 13 is performed by the expandable bag 25 of the assistant device for dental implant surgery A, so that nothing is introduced into the interspace between the maxillary sinus membrane 13 and the maxilla 11, which is formed by the separation. Accordingly, the maxillary sinus membrane 13 is not damaged or infected, and is thus free from disease. Conversely, when the maxillary sinus membrane 13 is elevated by using a rod type tool according to the prior art, the membrane may be damaged. This is the same when water, e.g. a saline solution is directly injected between the maxillary sinus membrane and the maxilla so as to elevate the membrane. Although the saline solution is clean water, a foreign substance can be eventually intruded and remain between the maxillary sinus membrane 13 and the maxilla 11, so that the maxillary sinus may be infected due to secondary disease such as inflammation of the maxillary sinus, caused by the secondary contamination due to the foreign substance.

However, according to the assistant device for dental implant surgery A of the present invention, a foreign substance is introduced into only the maxillary sinus membrane 13 and the maxilla 11, and the smooth expandable bag 25 used herein enables the maxillary sinus membrane 13 to be safely separated from the maxilla 11 without damaging the membrane 13.

In the assistant device for dental implant surgery A, in the state where the cylindrical main support section 22 with the internal space 24 is inserted into the maxillary hole 12 formed in the maxilla 11, a saline solution or gas is supplied to the expandable bag 25 via the internal space 24 in the regulator 23 side.

The expandable bag 25 is integrally attached, at one portion thereof adjacent to the regulator 23, to a portion of the space 24 adjacent to the regulator 23, and is freely movable, at the other portion thereof, which is in the upper portion of the main support section 22. Thus, the expandable bag 25 is inflated in the upper direction (the upper direction in the drawing) of the support section 22, i.e. toward the maxillary sinus 10, by the saline solution or gas.

Thus, the maxillary sinus membrane 13, which is attached to the maxilla 11 as illustrated in FIGS. 2 to 4, is partially separated from the maxilla 11 as illustrated in FIG. 6 by the expandable bag 25. In particular, according to the present invention, the degree of the inflation of the expandable bag 25 can be acquired by regulating the quantity of saline solution or gas supplied to the expandable bag 25, with the result that the degree of elevation of the maxillary sinus membrane 13 can also be advantageously known. The degree of the elevation of the maxillary sinus membrane can be made different according to the thickness of the remaining maxilla 11 because the depth of placement of a fixture is restricted. Also, since the commonly used fixture may have a different length, the degree of elevation of the maxillary sinus membrane should be made different according to the length of the fixture, the thickness of the remaining maxilla 11, and the like. In the assistant device for dental implant surgery A according to the present invention, the maxillary sinus membrane is elevated according to the dimensions such as the remaining height of the remaining maxilla 11 and the corresponding fixture, there is no risk to unnecessarily elevate the maxillary sinus membrane. In particular, if a tool of the prior art is used; several places of the maxillary sinus membrane have to be arbitrarily elevated using the tool. In the present invention, the maxillary sinus membrane is elevated uniformly, so that safe, quick elevation can be advantageously obtained.

Since the commonly used fixture has the length of approximately 7 mm to 14 mm, the alveolar bone (or the maxilla) should have the thickness of 8 mm or more, or approximately 15 mm, if sufficiently used, in order to place such a fixture for dental implant. Of course, many fixtures have the length of 8 mm to 12 mm.

However, the maxillary sinus and the maxilla of a person missing his tooth by nature have a characteristic in that the thickness of the maxilla is gradually thinned in the downward direction so that the maxillary sinus is expanded.

Thus, if the thickness of the maxilla of a person with missing tooth is not enough to place a fixture for implant, an artificial bone should be formed in the maxillary sinus above the maxilla. However, if the maxillary sinus membrane is damaged during the formation process, there is risk to cause disease, such as inflammation of the maxillary sinus, due to damage of the maxillary sinus membrane.

However, according to the assistant device for dental implant A of the invention, the maxillary sinus membrane 13 is separated from the maxilla 11 so as to secure a sufficient space between the maxillary sinus membrane 13 and the maxilla 11 as described before, the artificial bone 41 is formed in that space, and the implant fixture 42 is placed in that bone, thereby completing the implant surgery.

To this end, the maxilla 11 is first formed with the maxillary hole 12 into which the main support section 22 of the assistant device for dental implant surgery A can be fitted. The maxillary hole 12 is formed by removing the alveolar bone (or the maxilla) using a tool for implant surgery.

It is of course that, although not shown in the drawings, the shape of the maxillary hole 12 formed and the process of removing the maxilla can be provided by various methods according to patient s conditions and surgery statuses.

Further, it is also natural that the size of the maxillary hole 12 formed in the maxilla 11 can be suitably determined according to the shape and the size of the fixture 42, and the main support section 22, the expandable bag 25 and regulator 23 of the assistant device for implant surgery A of the present invention.

If the maxillary hole 12 is formed to have the size slightly smaller than or substantially identical to a diameter of the main support section 22 so as to allow the main support section 22 to be directly inserted into the maxillary hole 12, the main support section 22 can be fitted into the maxillary hole 12 by screwing the same with a little movement. For easier insertion, the main support section 22 may have a self-tapping blade on the upper portion thereof. Further, the upper portion of the support section has a shape so as not to damage the maxillary sinus membrane, and remove projections formed in the maxillary hole 12.

Further, in the assistant device for dental implant surgery A according to another embodiment of the present invention, the main support section 22 may be provided with a threaded portion 221 on an outer surface thereof as illustrated in FIGS. 1 to 6. The main support section 22 is inserted and fixed into the maxillary hole 12 so that it is maintained in a fixed state to the maxilla 11 without causing vibrations and shaking. Thus, even though an inflating process is carried out through injection of a saline solution or gas by the pressure inflator 30, the main support section 22 is not agitated so that the maxillary hole 12 is not damaged while the inflating process is stably implemented.

Even in the case that the main support section 22 is not provided with the threaded portion on its outer surface, the saline solution or gas, which is supplied in the expandable bag 25 to lift the maxillary sinus membrane 13, is not discharged from the expandable bag 25. Accordingly, the inflating process can be advantageously conducted even if the main support section 22 is slightly agitated from the maxillary hole 12.

Further, in the case that the main support section 22 is screw-fastened into the maxillary hole 12 by the threaded portion thereof, the inflating process is stably implemented since the main support section 22 is more strongly fixed to the maxilla 11 of the maxillary hole 12.

In the assistant device A of the invention, the main support section 22 may be provided with an auxiliary fixture 26, which is screwed to the threaded portion 221 of the support section 22. The auxiliary fixture 26 is fixed into the maxillary hole 12 to a depth corresponding to the level by which the auxiliary fixture 26 is screwed

While the implant fixture to be placed in the maxilla 11 (or alveolar bone) should generally have a length of approximately 10 mm, the maxilla 11 in which the maxillary sinus is expanded has a thinner thickness than the length. Thus, if the insertion depth of the main support section 22 into the maxillary hole 12 of the maxilla 11 can be measured with a pre-diagnosis inspection, the auxiliary fixture 26 is screw-engaged with the main support section 22 to a length measured, and then is fastened to the maxillary hole 12. Thus, the main support section 22 is inserted into the maxillary hole 12 to the length that the fixture 26 is screw-engaged with the main support section 22.

Further, in a coupled stat of the main support section 22, which is inserted into the maxillary hole 12, when the auxiliary fixture 26 is turned relative to the main support section 22 so as to move toward the maxilla 11, an upper surface of the auxiliary fixture 26 is brought into close contact with a lower surface of the maxilla 11. Consequently, the fastening force by the threaded portion of the main support section 22 screwed into the maxillary hole 12 and the drawing force by the auxiliary fixture contacting the maxilla 11 react, as drag force, relative to each other, so that the main support section 22 is thus combined stronger with the maxilla 11.

Further, the main support section 22 may be provided, on a leading end thereof, with a cutting insert (not shown) which facilitates the insertion while enlarging the maxillary hole 12 when it rotates and is inserted into the maxillary hole 12. The cutting insert may be formed into a shape of a common cutting insert capable of self-tapping in a conventional implant fixture. That is, for example, the cutting insert is formed such that a portion of a thread, which is formed on the outer surface of the main support section 22, is cut in a lengthwise direction, a cut surface faces the rotation direction of the thread, and an outer edge defined by the cut surface has a shape of a right-angled blade or an acute-angled blade in the cross-section. By the right-angled blade or acute-angled blade, a portion of the maxilla 11 on the sidewall of the maxillary hole 12 is reamed and enlarged, so that the main support section 22 is easily inserted into the maxillary hole.

Alternatively, the main support section 22 is formed such that, as shown in FIG. 1, an expanding thread, the diameter of which gradually increases from the upper portion to the lower portion, is formed on the outer surface thereof. Preferably, the outer diameter of the thread 221 of the main support section 22 is slightly larger than the inner diameter of the maxillary hole 12. Thus, the main support section 22 is fixed stronger to the maxilla 11 of the maxillary hole 12 by screw-engagement. To this end, the shape of the main support section 22 is preferably formed so as to possibly implement a self-tapping.

In such an expanding thread 222, since the outer diameter of the upper portion thereof is smaller than the inner diameter of the maxillary hole 12, the main support section is easily inserted into an inlet of the maxillary hole 12 without a separate rotating operation. Like this, when the regulator 23 is rotated in a screw-fastening direction in a state in which the expanding thread 222 of the upper portion of the main support section 22 is fitted into the maxillary hole 12, the expanding thread 222 of the main support section is firstly inserted into the inlet of the maxillary hole 12 for screw-engagement, and the threaded portion 221 of the main support section 22 is then screw-fastened to the maxillary hole 12. Thus, the main support section 22 is easily engaged with and disengaged from the maxillary hole 12.

Like this, the main support section 22 is strongly engaged with the maxillary hole 12 by screw-engagement. Further, the main support section 22 is formed such that the expanding thread expanding from the upper portion to the lower portion is provided on the outer surface in the upper leading end portion of the main support section, and a cutting edge for self-tapping is formed for easy screw-engagement.

Further, to facilitate the screw-engagement of the assistant device for dental implant surgery A with the maxillary hole 12, the assistant device A may have “−” or “+” type groove at the bottom of the regulator 23, so that the assistant device can be rotated by using a “−” or “+” type tool so as to be screw-engaged with the maxillary hole 12. Further, as shown in FIG. 1, the outer surfaces of the regulator 23 and the auxiliary fixture 26 are provided with vertical grooves for preventing slipping upon rotation. The construction is not limited to the above, but the outer surfaces of the regulator 23 and the auxiliary fixture 26 may have a hexagonal cross-section. Of course, in such a construction, the assistant device can be easily rotated by using a corresponding tool to the shape.

Further, the outer diameter of the auxiliary fixture 26 may be formed similar to, or larger or smaller than that of the regulator 23. The diameter, the shape, and the like of the auxiliary fixture 26 and the regulator 23 are properly selected according to a surgical environment, a patient s condition, a disease type concerning a maxilla and a maxillary sinus.

A pressure inflator 30 is further provided so as to inflate the expandable bag 25 with the main support section 22 engaged with the maxillary hole 12 of the maxilla 11 as shown in FIGS. 5 and 6. In FIGS. 5 and 6, the pressure inflator 30 has a shape of a syringe, but it is not limited thereto. For example, in the case that an inflator device is provided so as to supply saline solution or gas to the expandable bag 25, an injecting connector for the inflator device may be provided. Thus, the injecting connector is coupled to the side portion of the regulator so as to inject the saline solution or gas into the expandable bag, thereby inflating the expandable bag upward the maxillary sinus.

Further, in case of the syringe type pressure inflator 30 as shown in FIGS. 5 and 6, the connector 32 is inserted into and coupled to the space 24, so that the expandable bag 25 can be inflated by gas or liquid contained in the pressure inflator 30.

The connector 32 may be covered with a rubber packing 33 on an outer surface thereof so as to prevent the leaking of the saline solution or gas through a gap between the space and the connector.

Further, while the engagement between the connector and the space may be implemented in an interference-fit manner, the engaging method may be a screw-engagement method so that the connector and the space are provided with an external screw and an internal screw (not shown), respectively, and vice versa.

Then, the expandable bag 25 is gradually inflated, finally into the shape shown in FIG. 6, by the saline solution or gas supplied from the pressure inflator 30. Thus, the maxillary sinus 13 is gradually separated from the maxilla 11.

When the maxillary sinus 13 is separated from the maxilla 11, the assistant device for dental implant surgery A is removed from the maxilla 11, and the graft material of an artificial bone 41 is then injected through the maxillary hole 12 of the maxilla 11, thereby forming the artificial bone between the maxilla 11 and the maxillary sinus 13 as shown in FIG. 7.

After the completion of the molding of the artificial bone, the implant fixture 42 is placed therein, and the dental implant surgery is then carried out.

While the present invention has been shown and described in connection with the exemplary embodiments, it will be apparent to those skilled in the art that modifications and variations can be made without departing from the spirit and scope of the invention as defined by the appended claims.

1. An assistant device for dental implant surgery, comprising:
a cylindrical main support section having a regulator section integrally formed on a lower end portion thereof; and
an expandable bag provided in an internal space of the support section, wherein, when the expandable bag is inflated, a maxillary sinus membrane is elevated into a maxilla.

2. The assistant device for dental implant surgery according to claim 1, wherein the main support section has a threaded portion on an outer surface thereof so as to be fixed into a maxillary hole of the maxilla.

3. The assistant device for dental implant surgery according to claim 2, wherein the main support section is provided with an auxiliary fixture, which is screw-engaged with the threaded portion of the support section, so that the support section is fitted into the maxillary hole by a depth according to a level by which the auxiliary fixture is screwed.

4. The assistant device for dental implant surgery according to claim 1, wherein a pressure inflator is further connected to the internal space so as to inflate the expandable bag with gas or liquid supplied from the pressure inflator.

5. The assistant device for dental implant surgery according to claim 4, wherein the pressure inflator is provided, in one side thereof, with an injecting connector, which is inserted into and is connected to the space, and the connector is covered with a rubber packing on an outer surface thereof.

6. The assistant device for dental implant surgery according to claim 2, wherein a pressure inflator is further connected to the internal space so as to inflate the expandable bag with gas or liquid supplied from the pressure inflator.

7. The assistant device for dental implant surgery according to claim 3, wherein a pressure inflator is further connected to the internal space so as to inflate the expandable bag with gas or liquid supplied from the pressure inflator.
